(19) United States
(12) Patent Application Publication
(10) Pub. No.: US 2019/0222541 A1
(43) Pub. Date: Jul. 18, 2019

(54) INFORMATION PROCESSING APPARATUS, INFORMATION PROCESSING SYSTEM, AND INFORMATION PROCESSING METHOD

(71) Applicant: KYOCERA Document Solutions Inc., Osaka-shi (JP)

(72) Inventor: Tadaaki Akimoto, Osaka (JP)

(21) Appl. No.: 16/245,512

(22) Filed: Jan. 11, 2019

(30) Foreign Application Priority Data
Jan. 18, 2018 (JP) 2018-006025

(51) Int. Cl. H04L 12/58

(52) U.S. Cl. CPC H04L 51/04; H04L 51/06; H04L 51/16; H04L 51/24

(57) ABSTRACT

An information processing apparatus includes a reception processing portion, a display processing portion, and a notification processing portion. The reception processing portion receives a first message from a first information processing apparatus. The display processing portion displays, on a display portion, the first message received from the reception processing portion. When an input operation is started, the notification processing portion associates input start information indicating that the input operation has started, with identification information of the first message, and transmits the input start information and the identification information to the first information processing apparatus, the input operation being an operation of inputting one or more characters for a second message to be transmitted to the first information processing apparatus, in an input field displayed on the display portion.

### INCORPORATION BY REFERENCE

This application is based upon and claims the benefit of priority from the corresponding Japanese Patent Application No. 2018-006025 filed on Jan. 18, 2018, the entire contents of which are incorporated herein by reference.

### BACKGROUND

The present disclosure relates to an information processing apparatus, an information processing system, and an information processing method.

In recent years, so-called chat is widely used, in which users use mobile terminals connected by a communication network such as the internet to communicate with one another by exchanging messages or the like in real-time.

### SUMMARY

An information processing apparatus according to the present disclosure includes a reception processing portion, a display processing portion, and a notification processing portion. The reception processing portion receives a first message from a first information processing apparatus. The display processing portion displays, on a display portion, the first message received from the reception processing portion. When an input operation is started, the notification processing portion associates input start information indicating that the input operation has started, with identification information of the first message, and transmits input start information and identification information to the first information processing apparatus, the input operation being an operation of inputting one or more characters for a second message to be transmitted to the first information processing apparatus, in an input field displayed on the display portion.

An information processing system according to the present disclosure is configured to transmit and receive messages between a first information processing apparatus and a second information processing apparatus. The second information processing apparatus includes a first reception processing portion, a first display processing portion, and a first notification processing portion. The first reception processing portion receives a first message from the first information processing apparatus. The first display processing portion displays, on a first display portion, the first message received by the first reception processing portion. When an input operation is started, the first notification processing portion associates input start information indicating that the input operation has started, with identification information of the first message, and transmits input start information and identification information to the first information processing apparatus, the input operation being an operation of inputting one or more characters for a second message to be transmitted to the first information processing apparatus, in an input field displayed on the display portion. The first information processing apparatus includes a second display processing portion and a second notification processing portion. The display processing process displays the first message on a second display portion. When the input start information is received from the first notification processing portion, the second notification processing portion adds to the first message notification information indicating that one or more characters for the second message are being input in the second information processing apparatus, and displays the notification information on the second display portion, based on identification information of the first message associated with input start information.

An information processing method according to the present disclosure includes receiving a first message from a first information processing apparatus, displaying on a display portion the first message that is received, and when an input operation is started, associating input start information indicating that the input operation has started, with identification information of the first message, and transmitting input start information and identification information to the first information processing apparatus, the input operation being an operation of inputting one or more characters for a second message to be transmitted to the first information processing apparatus, in an input field displayed on the display portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an information processing system according to an embodiment of the present disclosure.

FIG. 2 is a diagram showing an example of a display screen of a mobile terminal (information processing apparatus) according to the embodiment of the present disclosure.

FIG. 3 is a diagram showing an example of the display screen of the mobile terminal (information processing apparatus) according to the embodiment of the present disclosure.

FIG. 4 is a diagram showing an example of the display screen of the mobile terminal (information processing apparatus) according to the embodiment of the present disclosure.

FIG. 5 is a diagram showing an example of the display screen of the mobile terminal (information processing apparatus) according to the embodiment of the present disclosure.

FIG. 6 is a diagram showing an example of the display screen of the mobile terminal (information processing apparatus) according to the embodiment of the present disclosure.

FIG. 7 is a diagram showing an example of the display screen of the mobile terminal (information processing apparatus) according to the embodiment of the present disclosure.

FIG. 8 is a diagram showing an example of the display screen of the mobile terminal (information processing apparatus) according to the embodiment of the present disclosure.

FIG. 9 is a diagram showing an example of the display screen of the mobile terminal (information processing apparatus) according to the embodiment of the present disclosure.

FIG. 10 is a diagram showing a table including information of messages stored in a storage portion in the mobile terminal (information processing apparatus) according to the embodiment of the present disclosure.

FIG. 11 is a flowchart showing an example procedure of a messaging process executed in the mobile terminal (information processing apparatus) according to the embodiment of the present disclosure.

FIG. 12 is a diagram showing an example of the display screen of the mobile terminal (information processing apparatus) according to the embodiment of the present disclosure.

FIG. 13 is a diagram showing an example of the display screen of the mobile terminal (information processing apparatus) according to the embodiment of the present disclosure.

FIG. 14 is a diagram showing an example of the display screen of the mobile terminal (information processing apparatus) according to the embodiment of the present disclosure.

FIG. 15 is a diagram showing an example of the display screen of the mobile terminal (information processing apparatus) according to the embodiment of the present disclosure.

FIG. 16 is a diagram showing an example of the display screen of the mobile terminal (information processing apparatus) according to the embodiment of the present disclosure.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

An information processing apparatus according to the present disclosure may be a mobile terminal such as a mobile phone, a smartphone, or a tablet terminal, or may be a PC (personal computer). In addition, the information processing apparatus according to the present disclosure may be a server connected to the mobile terminal or the like via a network. Hereinafter, an example is given of a case where the information processing apparatus according to the present disclosure is the mobile terminal.

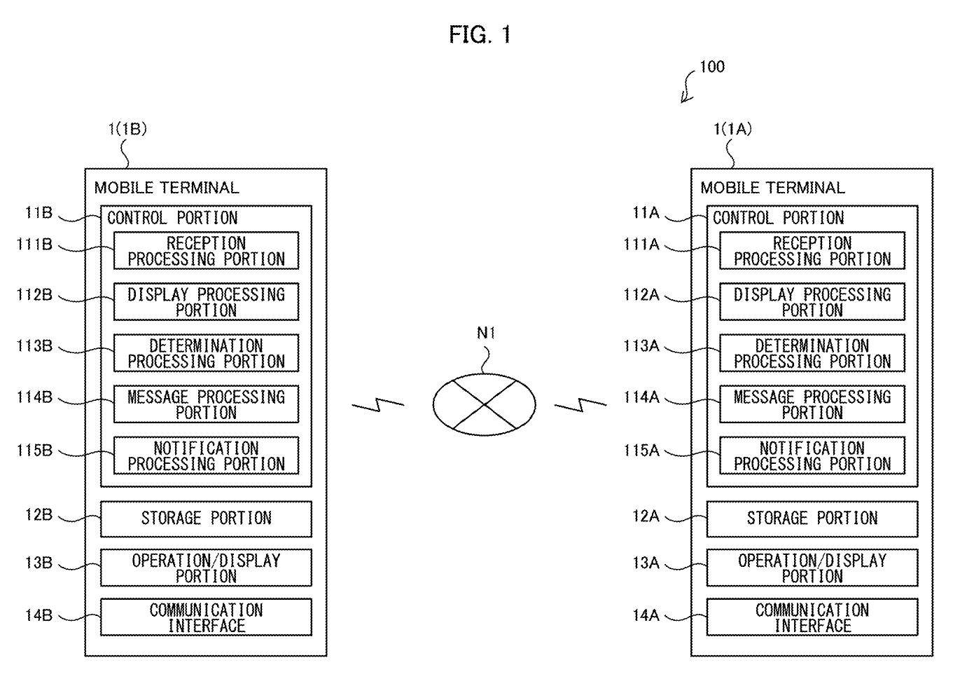

As shown in FIG. 1, an information processing system 100 according to an embodiment of the present disclosure includes a plurality of mobile terminals 1. The plurality of mobile terminals 1 can communicate with one another via a communication network N1, such as the internet, a LAN, a WAN, or a public telephone line. For convenience of explanation, FIG. 1 shows two mobile terminals 1A and 1B. It is noted that there may be three or more mobile terminals 1 according to the present disclosure.

Hereinafter, a user A uses the mobile terminal 1A, and a user B uses the mobile terminal 1B. In addition, the user A and the user B respectively use the mobile terminal 1A and 1B to exchange messages (perform communication) using a communication tool such as chat or email. It is noted that the messages may be sentences, characters, images, or voice messages, and include various types of information that can be transmitted and received by the communication tool.

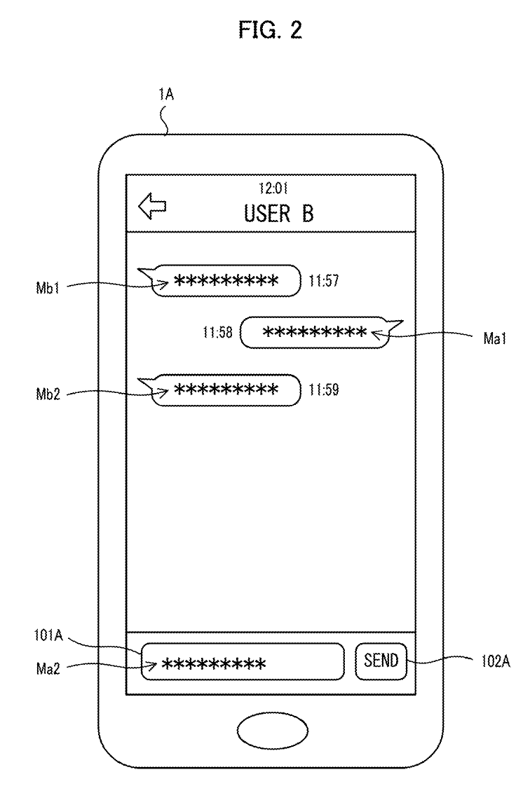

Here, an example is given of a flow of the communication. FIG. 2 shows a display portion (display screen) of the mobile terminal 1A used by the user A. The display portion displays a name of the user B who is on a receiving end, messages Mb1 and Mb2 received from the mobile terminal 1B of the user B, a message Ma1 created by the user A and transmitted to the mobile terminal 1B, and a message Ma2 being created (characters being input) by the user A. It is noted that the message Ma2 represents a reply message in response to the message Mb2. In addition, the display portion includes a character input field 101A in which the user A inputs characters when creating a message, and an operation portion (a send button 102A) for transmitting the created message to the mobile terminal 1B. Furthermore, the display portion displays a present time and a transmitted time (or received time) of each message.

FIG. 2 shows that the message Mb1 was transmitted from the mobile terminal 1B at “11:57”. In addition, FIG. 2 shows that the reply message Ma1 in response to the message Mb1 was transmitted from the mobile terminal 1A at “11:58”. In addition, FIG. 2 shows that the reply message Mb2 in response to the reply message Ma1 was transmitted from the mobile terminal 1B at “11:59”. In addition, the FIG. 2 shows that at present (“12:01”), the user A is creating the reply message Ma2 (inputting characters) in the mobile terminal 1A in response to the message Mb2.

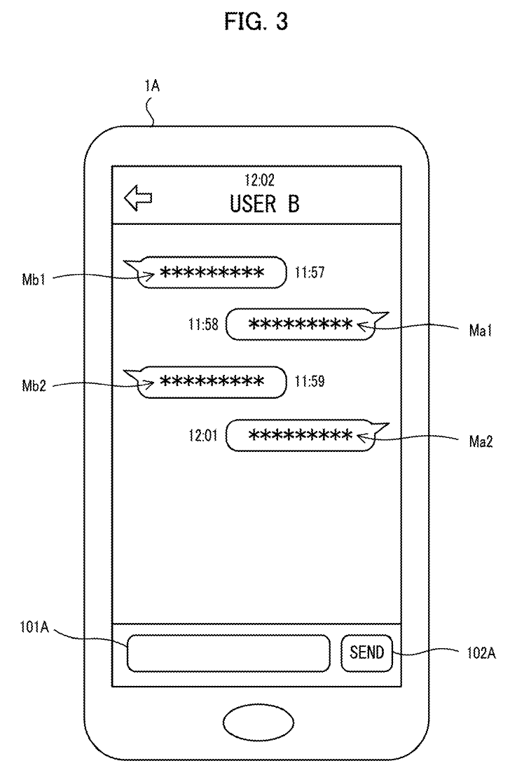

As shown in FIG. 3, when the user A finishes creating the reply message Ma2 and presses (selects) the send button 102A, the reply message Ma2 is transmitted to the mobile terminal 1B and displayed on the display portion as a transmitted message. The transmitted time “12:01” is shown near the reply message Ma2.

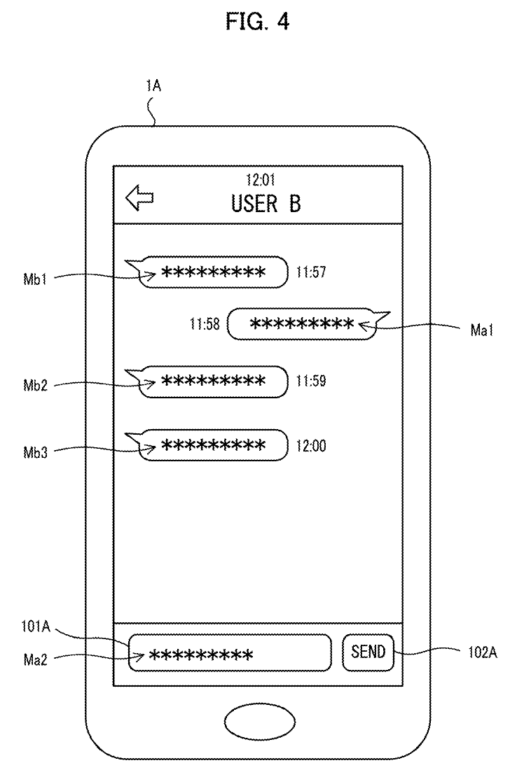

Generally, as shown in FIG. 2 and FIG. 3, the user A and the user B alternately transmit messages to progress the communication. However, as shown in FIG. 4, the user B may transmit a next message Mb3 after transmitting the message Mb2, before receiving the reply message (the message Ma2) from the user A in the mobile terminal 1B. That is, the mobile terminal 1A may receive the next message Mb3 from the mobile terminal 1B while the user A is creating the reply message Ma2 in response to the message Mb2. In this case, on the display portion of the mobile terminal 1A, the message Mb3 is shown following the message Mb2.

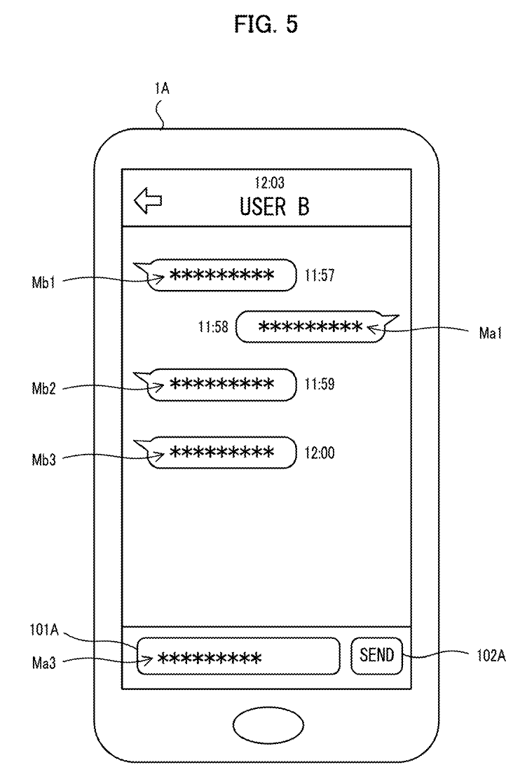

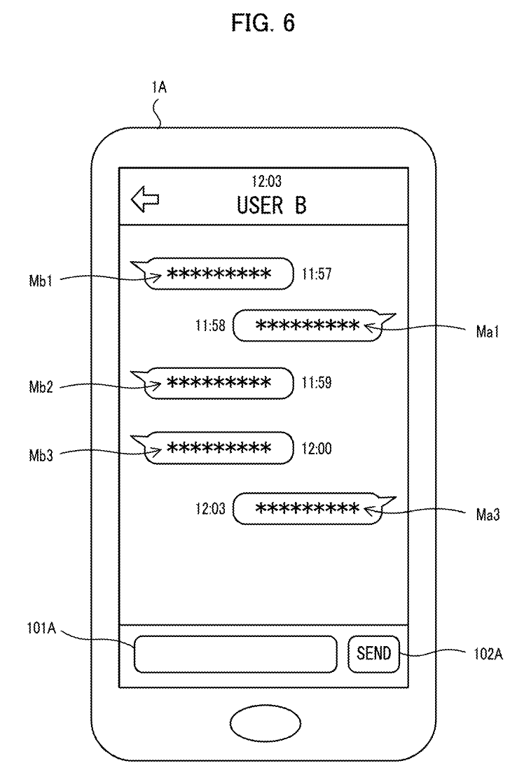

In such a case, it becomes unnecessary for the user A to transmit the reply message Ma2 in response to the message Mb2, and the user A must create a new reply message in response to the newest message Mb3. Accordingly, the user A must delete the characters of the reply message Ma2 that is being created, and create a reply message Ma3 in response to the message Mb3 (see FIG. 5). When the user A finishes creating the reply message Ma3 and presses the send button 102A, the reply message Ma3 is transmitted to the mobile terminal 1B and displayed on the display portion as the transmitted message, as shown in FIG. 6.

In this way, in the case where a first message and a second message are successively transmitted from the user B, the user A is unable to communicate a first reply message being created in response to the first message, the user B becomes unhappy when the first reply message does not come from the user A, and communication cannot be performed smoothly and efficiently.

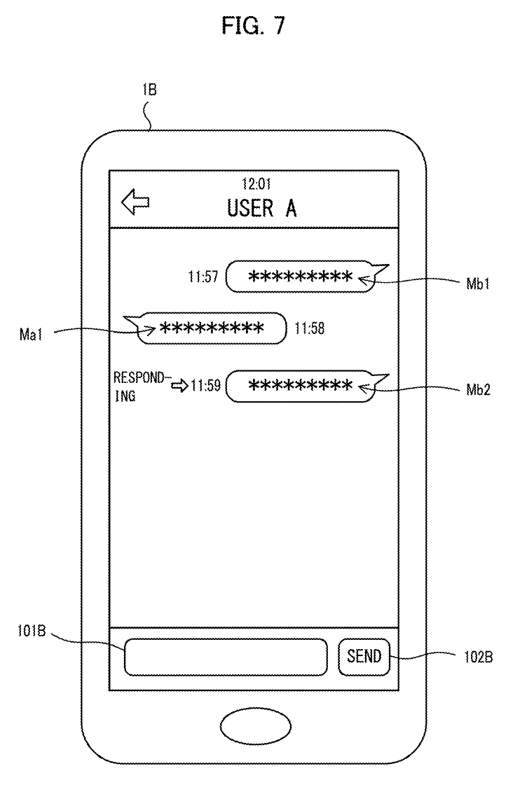

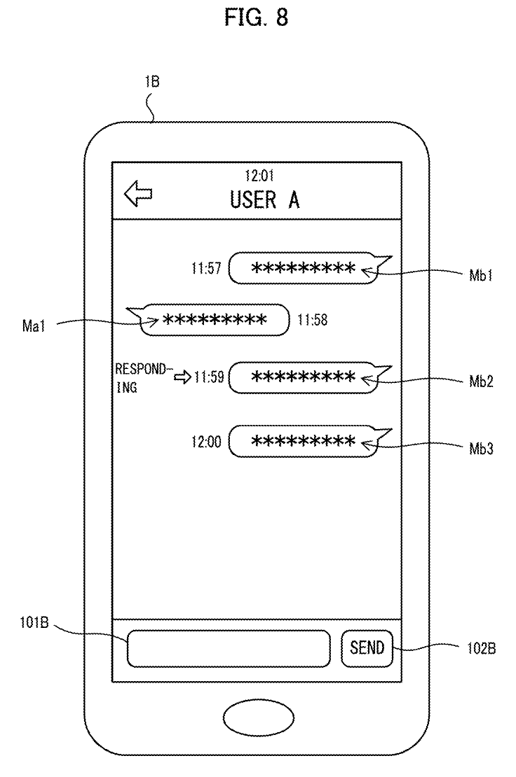

To solve this issue, the mobile terminal 1 according to the present embodiment can be used to improve efficiency of communication performed by transmitting and receiving messages. Specifically, the mobile terminal 1 includes a configuration (characteristic configuration) in which the user B is notified that the user A is creating (responding with) the first reply message (reply message Ma2) in response to the first message (message Mb2) (that the user A has started inputting characters). With this configuration, as shown in FIG. 7, the user B is able to recognize that the user A is creating the reply message Ma2 in response to the message Mb2. Furthermore, as shown in FIG. 8, even when the user B transmits the next message Mb3 while the user A is creating the reply message Ma2 in response to the message Mb2, the user B can recognize that the user A is creating the reply message Ma2 in response to the message Mb2.

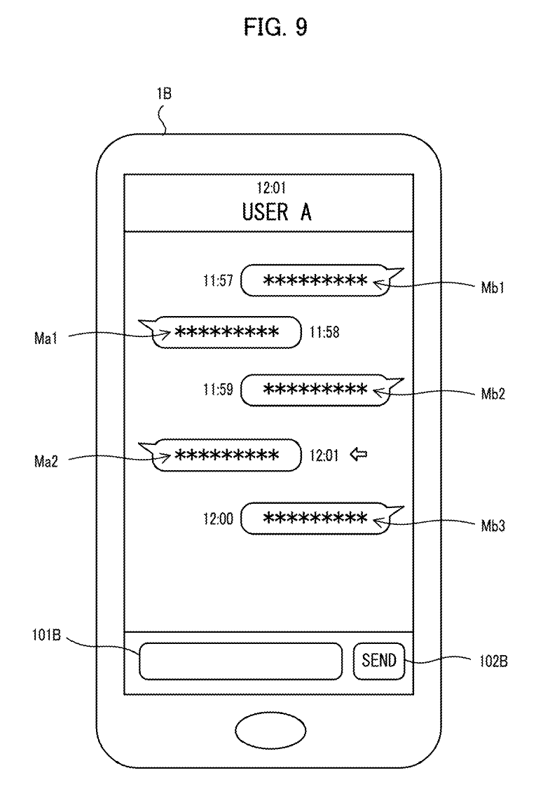

In addition, as shown in FIG. 9, when the user A finishes creating the reply message Ma2 and presses the send button 102A, the mobile terminal 1B receives the reply message Ma2, and displays the reply message Ma2 in between the message Mb2 and the message Mb3.

A description is given below of a detailed configuration including the characteristic configuration of the mobile terminal 1 according to the present embodiment. The plurality of mobile terminals 1 have the same configuration as one another. Here, the mobile terminal 1A used by the user A and the mobile terminal 1B used by the user B are given as examples according to the example described above. It is noted that the mobile terminal 1A and the mobile terminal 1B have the same functions, but the functions of the mobile terminal 1A and the mobile terminal 1B are explained in distinction from each other in correspondence to the example above, for convenience of explanation. It is noted that in the description below, “message” is expressed as “reply message” as necessary.

[Mobile Terminal 1A]

As shown in FIG. 1, the mobile terminal 1A includes a control portion 11A, a storage portion 12A, an operation/display portion 13A, and a communication interface 14A.

The communication interface 14A connects the mobile terminal 1A to the communication network N1 in a wired or wireless manner, and executes data communication according to a specific communication protocol with an external device such as another mobile terminal 1 via the communication network N1.

The operation/display portion 13A is a user interface including a display portion such as a liquid crystal display or an organic EL display for displaying various types of information, and an operation portion such as a mouse, keyboard, or touch panel for receiving operations from the user A. The operation/display portion 13A includes, for example, the send button 102A (see FIG. 2) as the operation portion.

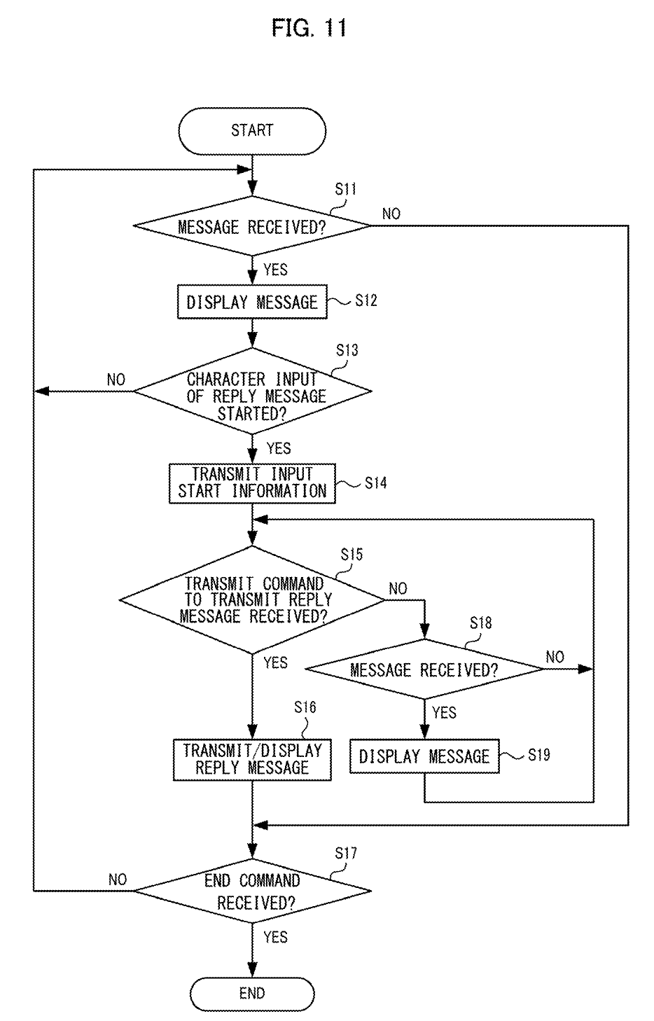

The storage portion 12A is a nonvolatile storage portion such as an HDD (Hard Disk Drive), SSD (Solid State Drive), or flash memory for storing various types of information. For example, a control program is stored in the storage portion 12A, such as a message processing program for causing the control portion 11A to execute a messaging process (see FIG. 11) described below. For example, the message processing program is recorded in a non-transitory computer-readable recording medium such as a CD or a DVD, read by a readout device (not shown) such as a CD drive or DVD drive electrically connected to the mobile terminal 1A, and stored in the storage portion 12A.

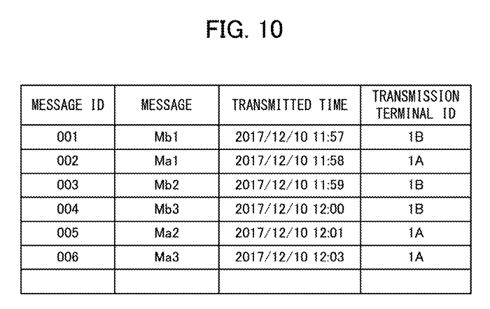

In addition, a message created in the mobile terminal 1A, and a message received from another mobile terminal 1 (for example, the mobile terminal 1B) are stored (saved) in the storage portion 12A. In addition, each of the messages stored in the storage portion 12A is associated with identification information of the message, transmitted time information, and identification information of the transmission terminal. FIG. 10 shows an example of a table including information of messages stored in the storage portion 12A.

The control portion 11A includes control devices such as a CPU, a ROM, and a RAM. The CPU is a processor for executing various types of arithmetic processing. The ROM is a nonvolatile storage portion in which control programs, such as a BIOS and OS for causing the CPU to execute the various types of processing, are preliminarily stored. The RAM is a volatile or nonvolatile storage portion in which various types of information are stored, and is used as temporary storage memory (work area) for the various types of processing executed by the CPU. The control portion 11A controls the mobile terminal 1A by causing the CPU to execute various types of the control programs preliminarily stored in the ROM or the storage portion 12A.

Specifically, the control portion 11A includes a reception processing portion 111A, a display processing portion 112A, a determination processing portion 113A, a message processing portion 114A, and a notification processing portion 115A. It is noted that the control portion 11A functions as the various processing portions by causing the CPU to execute various types of processing according to the message processing program. In addition, some or all of the processing portions included in the control portion 11A may be configured by one or more electronic circuits. It is noted that the message processing program may allow a plurality of processors to function as the various types of processing portions.

The reception processing portion 111A receives (obtains) a message transmitted from another mobile terminal 1. For example, the reception processing portion 111A of the mobile terminal 1A receives a message Mb transmitted from the mobile terminal 1B. The reception processing portion 111A saves the received message Mb in the storage portion 12A in association with identification information (ID) of the message Mb, transmitted time information, and the identification information (ID) of the transmission terminal (see FIG. 10).

The display processing portion 112A displays the message (message Mb) received by the reception processing portion 111A on the display portion of the operation/display portion 13A (see FIG. 2 and the like). In addition, the display processing portion 112A displays a message Ma created in the mobile terminal 1A on the display portion of the operation/display portion 13A (see FIG. 2 and the like). In addition, the display processing portion 112A displays the present time on the display portion of the operation/display portion 13A, and displays the transmitted time (or the received time) of each message near each message (see FIG. 2 and the like). The display processing portion 112A displays other types of information on the display portion of the operation/display portion 13A.

The determination processing portion 113A determines whether or not the user A has started inputting characters (whether or not the user A is inputting characters) in the character input field 101A of the mobile terminal 1A.

The message processing portion 114A, for example, based on a command from the user A, transmits the message Ma created in the mobile terminal 1A to the mobile terminal 1B. Specifically, when the user A creates the message Ma and presses the send button 102A (see FIG. 2), the message processing portion 114A receives a command (transmit command) in response to the operation, and transmits the message Ma to the mobile terminal 1B.

In addition, the message processing portion 114A adds the identification information (ID) of the message Ma, the transmitted time information, and the identification information (ID) of the mobile terminal 1A to the message Ma, and transmits the message Ma added with the information, to the mobile terminal 1B.

Furthermore, the message processing portion 114A saves the message Ma in the storage portion 12A in association with the identification information (ID) of the message Ma, the transmitted time information, and the identification information (ID) of the mobile terminal 1A (see FIG. 10).

The notification processing portion 115A transmits to the mobile terminal 1B information (hereinafter referred to as input start information) that indicates that the user A has started inputting characters (that the user A is inputting characters) in the character input field 101A of the mobile terminal 1A. That is, the notification processing portion 115A notifies the mobile terminal 1B that the user A is inputting characters to the mobile terminal 1A. A detailed configuration of the notification processing portion 115A is described below.

[Mobile Terminal 1B]

As shown in FIG. 1, the mobile terminal 1B includes a control portion 11B, a storage portion 12B, an operation/display portion 13B, and a communication interface 14B. Descriptions of functions that are the same as those of the mobile terminal 1A are omitted as appropriate.

A control program such as a message processing program for causing the control portion 11B to execute the messaging process (see FIG. 11) described below, is stored in the storage portion 12B.

In addition, messages created in the mobile terminal 1B, and messages received from another mobile terminal 1 (for example, the mobile terminal 1A) are stored (saved) in the storage portion 12B. In addition, each of the messages stored in the storage portion 12B is associated with identification information of the message, transmitted time information, and identification information of the transmission terminal. When the mobile terminal 1B transmits and receives messages to and from the mobile terminal 1A, the same information (table) (see FIG. 10) as what is stored in the storage portion 12A of the mobile terminal 1A is stored in the storage portion 12B.

The control portion 11B controls the mobile terminal 1B by causing the CPU to execute various types of control programs preliminarily stored in the ROM or the storage portion 12B.

Specifically, the control portion 11B includes a reception processing portion 111B, a display processing portion 112B, a determination processing portion 113B, a message processing portion 114B, and a notification processing portion 115B.

The reception processing portion 111B receives (obtains) a message transmitted from another mobile terminal 1. For example, the reception processing portion 111B of the mobile terminal 1B receives the message Ma transmitted from the mobile terminal 1A. The reception processing portion 111B saves the received message Ma in the storage portion 12B (see FIG. 10).

The display processing portion 112B displays the message (the message Ma) received by the reception processing portion 111B on the display portion of the operation/display portion 13B (see FIG. 7). In addition, the display processing portion 112B displays the message Mb created in the mobile terminal 1B on the display portion of the operation/display portion 13B (see FIG. 7). In addition, the display processing portion 112B displays the present time on the display portion of the operation/display portion 13B, and displays the transmitted time (or the received time) of each message near each message (see FIG. 7). The display processing portion 112B displays other types of information on the display portion of the operation/display portion 13B.

The determination processing portion 113B determines whether or not the input start information has been received from the mobile terminal 1A.

The message processing portion 114B, for example, based on a command from the user B, transmits the message Mb created in the mobile terminal 1B to the mobile terminal 1A. Specifically, when the user B creates the message Mb and presses the send button 102B (see FIG. 7), the message processing portion 114B receives a command (transmit command) in response to the operation, and transmits the message Mb to the mobile terminal 1A.

In addition, the message processing portion 114B adds the identification information (ID) of the message Mb, the transmitted time information, and the identification information (ID) of the mobile terminal 1B to the message Mb, and transmits the message Mb added with the information, to the mobile terminal 1A.

Furthermore, the message processing portion 114B saves the message Mb in the storage portion 12B in association with the identification information (ID) of the message Mb, the transmitted time information, and the identification information (ID) of the mobile terminal 1B.

When the input start information is received from the mobile terminal 1A, the notification processing portion 115A adds notification information indicating that characters are being input to the mobile terminal 1A for the reply message Ma in response to the message Mb (indicating that the user A is responding), to the message Mb corresponding to the input start information, and displays the notification information on the display portion of the operation/display portion 13B. In FIG. 7, the notification information (“responding→”) added to the message Mb2 is displayed. A detailed configuration of the notification processing portion 115B is described below.

[Messaging Process]

Below, with reference to FIG. 11, a description is given of a messaging process executed in the mobile terminal 1A. For example, the messaging process is started when the mobile terminal 1A receives a message from the mobile terminal 1B. Here, the description mainly focuses on processing in the mobile terminal 1A. It is noted that the messaging process may be ended halfway in response to a specific operation on the mobile terminal 1A by the user A.

It is noted that one or multiple steps included in the messaging process described herein may be omitted as appropriate. In addition, steps in the messaging process may be executed in a different order as long as a similar effect is achieved. Furthermore, although the description herein uses an example of a case where the steps in the messaging process are executed by the control portion 11A of the mobile terminal 1A, in another embodiment, the execution of the steps in the messaging process may be distributed among a plurality of other processors.

Here, as in the example described above, the user A and the user B respectively use the mobile terminal 1A and the mobile terminal 1B to exchange messages (perform communication) using a communication tool such as chat. It is noted that the present disclosure may be regarded as an invention of an information processing method for executing one or multiple steps included in the messaging process.

<Step S11>

In step S11, when it is determined that the reception processing portion 111A of the mobile terminal 1A has received the message Mb1 from the mobile terminal 1B (S11: YES), the process moves to step S12. When it is determined that the reception processing portion 111A has not received the message Mb1 from the mobile terminal 1B (S11: NO), the process moves to step S17.

In addition, the reception processing portion 111A receives the identification information (ID) of the message Mb1, the transmitted time information, and the identification information (ID) of the mobile terminal 1B that are added to the message Mb1 received from the mobile terminal 1B, and saves the message Mb1 in the storage portion 12A in association with the information (see FIG. 10).

<Step S12>

In step S12, the display processing portion 112A displays the message Mb1 received by the reception processing portion 111A on the display portion of the operation/display portion 13A (see FIG. 2).

<Step S13>

In step S13, the determination processing portion 113A determines whether or not the user A has started inputting characters (whether or not the user A is inputting characters) in the character input field 101A of the mobile terminal 1A for the message Ma1 in response to the message Mb1. When the determination processing portion 113A determines that the user A has started inputting characters in the character input field 101A of the mobile terminal 1A (S13: YES), the process moves to step S14.

When the determination processing portion 113A determines that the user A has not started inputting characters in the character input field 101A of the mobile terminal 1A (S13: NO), the process returns to S11. Here, the user A is supposed to have started inputting characters in the character input field 101A, and the process moves to step S14.

<Step S14>

In step S14, the notification processing portion 115A transmits information (input start information) to the mobile terminal 1B, indicating that the user A has started inputting characters (that the user A is inputting characters) in the character input field 101A of the mobile terminal 1A. The input start information is described in a process below.

<Step S15>

In step S15, when it is determined that the message processing portion 114A receives from the user A a transmit command to transmit the reply message Ma1 (S15: YES), the process moves to step S16. When it is determined that the message processing portion 114A has not received a transmit command to transmit the reply message Ma1 (S15: NO), the process moves to step S18. Here, the message processing portion 114A is supposed to have received the transmit command from the user A, and the process moves to step S16.

<Step S16>

In step S16, the message processing portion 114A adds the identification information (ID) of the reply message Ma1, the transmitted time information, and the identification information (ID) of the mobile terminal 1A to the reply message Ma1, and transmits the reply message Ma1 added with the information, to the mobile terminal 1B. In addition, the message processing portion 114A saves the reply message Ma1 in the storage portion 12A in association with the identification information (ID) of the reply message Ma1, the transmitted time information, and the identification information (ID) of the mobile terminal 1A (see FIG. 10).

In addition, the display processing portion 112A displays the reply message Ma1 on the display portion of the operation/display portion 13A (see FIG. 2).

<Step S17>

In step S17, when the control portion 11A determines that an end command to end the messaging process has been received from the user A (S17: YES), the control portion 11A ends the messaging process.

When the control portion 11A determines that an end command to end the messaging process has not been received from the user A (S17: NO), and it is determined that the reception processing portion 111A has received a next reply message Mb2 (first message) from the mobile terminal 1B (S11: YES), the process moves to step S12, and the display processing portion 112A displays the reply message Mb2 on the operation/display portion 13A (see FIG. 2).

Next, when it is determined that the user A has started inputting characters in the character input field 101A of the mobile terminal 1A for the reply message Ma2 in response to the reply message Mb2 (S13: YES) (see FIG. 2), the notification processing portion 115A transmits the input start information to the mobile terminal 1B.

Here, the notification processing portion 115A adds identification information (ID) of the message to the input start information and transmits the input start information to the mobile terminal 1B. Specifically, the notification processing portion 115A adds, to the input start information, identification information (ID) of the message Mb received by the reception processing portion 111A from the mobile terminal 1B immediately before the user A started inputting the characters in the character input field 101A, and identification information of the message Ma that is created by characters being input in the character input field 101A. Here, the notification processing portion 115A adds the identification information (“003”) of the reply message Mb2 and the identification information (“005”) of the reply message Ma2 to the input start information.

When the notification processing portion 115B of the mobile terminal 1B receives the input start information from the mobile terminal 1A, the notification processing portion 115B adds the notification information to the message Mb corresponding to the identification information added to the input start information, and displays the notification information on the display portion of the operation/display portion 13B. Here, the notification processing portion 115B adds the notification information (“responding→”) to the reply message Mb2 corresponding to the identification information (“003”), and displays the notification information (see FIG. 7).

<Step S18>

Next, in step S15, when it is determined that the message processing portion 114A has not received a transmit command to transmit the reply message Ma2 from the user A (S15: NO), the process moves to step S18.

When, in the mobile terminal 1A, the reception processing portion 111A receives the next reply message Mb3 (third message) from the mobile terminal 1B (S18: YES) after, as shown in FIG. 2, the user A starts inputting characters in the character input field 101A for the reply message Ma2 (second message) in response to the reply message Mb2 (first message) (S13: YES) and before the message processing portion 114A receives the transmit command to transmit the reply message Ma2 from the user A (S15: NO), the process moves to step S19.

<Step S19>

In the step S19, the display processing portion 112A displays the reply message Mb3 received by the reception processing portion 111A on the display portion of the operation/display portion 13A (see FIG. 4). For example, the display processing portion 112A displays the reply message Mb3 directly below (adjacent to) the reply message Mb2 (see FIG. 4). Then, the process returns to step S15.

At this time, in the mobile terminal 1B, the message processing portion 114B transmits the reply message Mb3 to the mobile terminal 1A, and the display processing portion 112B displays the reply message Mb3 on the display portion of the operation/display portion 13B (see FIG. 8). In addition, the notification processing portion 115B continues displaying the notification information (“responding→”) added to the message Mb2 (see FIG. 8).

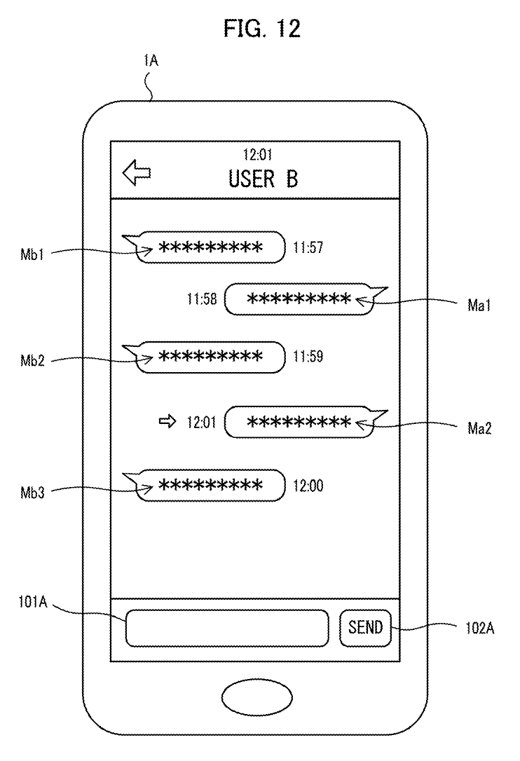

Next, the process returns to step S15, and when it is determined that the message processing portion 114A has received from the user A the transmit command to transmit the reply message Ma2 (S15: YES), the process moves to step S16. Then, in step S16, the message processing portion 114A transmits the reply message Ma2 to the mobile terminal 1B, and the display processing portion 112A displays the reply message Ma2 on the display portion of the operation/display portion 13A (see FIG. 12).

Here, in the mobile terminal 1A, the display processing portion 112A displays the reply message Ma2 directly below (adjacent to) the reply message Mb2, based on the identification information (“003”) added to the input start information (see FIG. 12). Here, the display processing portion 112A displays the reply message Ma2 in between the reply message Mb2 and the reply message Mb3. It is noted that the display processing portion 112A may display the notification information (for example, “→”) near the reply message Ma2.

In addition, in the mobile terminal 1B, when the reception processing portion 111B receives the reply message Ma2 corresponding to the identification information (“005”) added to the input start information from the mobile terminal 1A, the display processing portion 112B displays the reply message Ma2 directly below (adjacent to) the reply message Mb2 corresponding to the identification information (“003”) added to the input start information (see FIG. 9). Here, the display processing portion 112B displays the reply message Ma2 in between the reply message Mb2 and the reply message Mb3. It is noted that the display processing portion 112B may display the notification information (for example, “←”) near the reply message Ma2.

It is noted that the message processing portion 114A of the mobile terminal 1A may add, to the reply message Ma2, time information of when the user A started inputting characters for the message Ma2 in the character input field 101A (input start time information), and transmit the reply message Ma2 to the mobile terminal 1B. In this case, in the mobile terminal 1B, the display processing portion 112B displays the reply message Ma2 in between the reply message Mb2 and the reply message Mb3, based on the input start time information (for example, “11:59”) added to the reply message Ma2 received from the mobile terminal 1A (see FIG. 9). It is noted that a time (“12:01”) when the reply message Ma2 was transmitted from the mobile terminal 1A is displayed on the display portion of the operation/display portion 13B of the mobile terminal 1B.

After the processing in step S16, the process moves to step S17. The messaging process is executed as described above.

As described above, in the mobile terminal 1 (for example, the mobile terminal 1A) according to the present embodiment, when the user A starts inputting characters in the character input field 101A for the reply message Ma2 in response to the message Mb2, the notification processing portion 115A associates the input start information indicating that characters have started being input, with the identification information (“003”) of the message Mb2, and transmits the pieces of information to the mobile terminal 1B. Then, when the mobile terminal 1B receives the input start information, based on the identification information (“003”) of the message Mb2 associated with the input start information, the notification processing portion 115B adds, to the message Mb2, the notification information indicating that the characters for the reply message Ma2 are being input in the mobile terminal 1A, and displays the notification information on the display portion.

With this configuration, the user A can communicate to the user B that the user A is creating the reply message Ma2 in response to the message Mb2. In addition, since the user B can recognize that the user A is trying to reply to the message Mb2, the user B may wait to transmit the next message Mb3. Furthermore, even if the user B is creating the next message Mb3 or a later message Mb4 or the like, since the notification information is continuously displayed in the mobile terminal 1B, the user B can recognize that the user A is trying to reply to the message Mb2. As a result, communication can be performed efficiently.

The information processing apparatus according to the present disclosure is not limited to the configuration described above, and may have configurations as described below. Modified examples of the mobile terminal 1 described above are described below.

### Modified Example 1

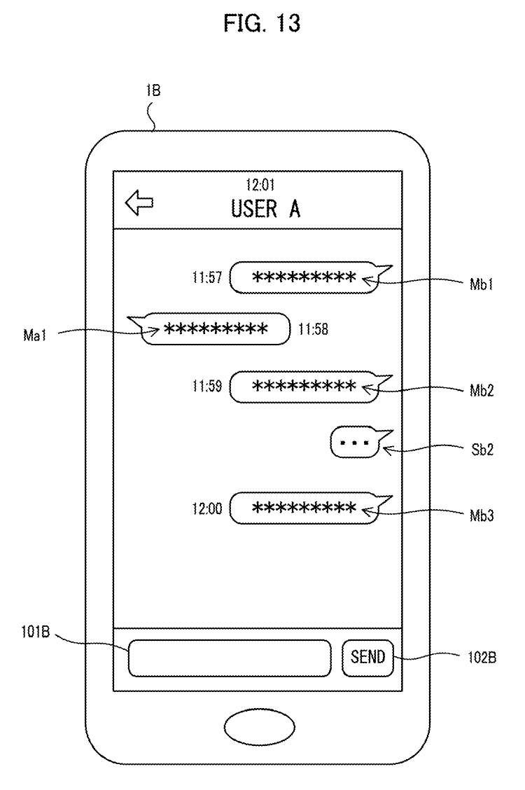

When the notification processing portion 115B of the mobile terminal 1B receives the input start information from the mobile terminal 1A, the notification processing portion 115B may add notification information Sb2 (see FIG. 13) indicating that characters are being input to the mobile terminal 1A for the reply message Ma2 in response to the message Mb2 (indicating that the user A is responding), to the message Mb2 corresponding to the input start information, and display the notification information Sb2 to the message Mb2 on the display portion of the operation/display portion 13B.

### Modified Example 2

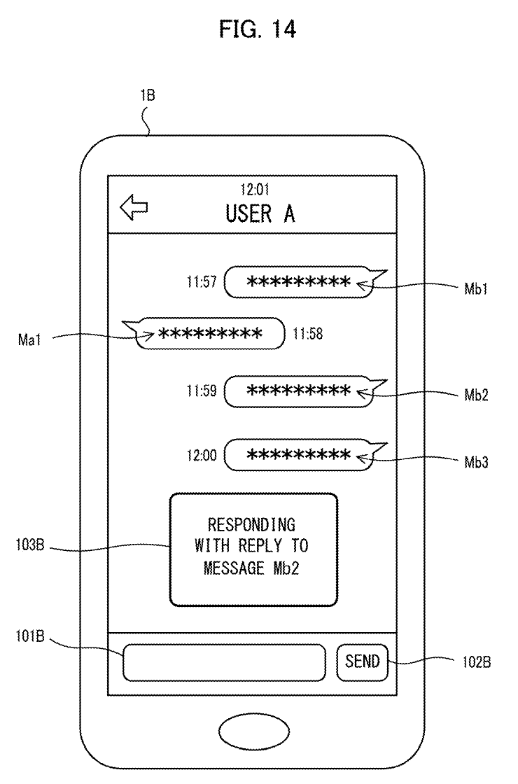

The notification processing portion 115B of the mobile terminal 1B may, as the notification information, display a message 103B (see FIG. 14) on the display portion of the operation/display portion 13B, indicating that characters are being input to the mobile terminal 1A for the reply message Ma2 in response to the message Mb2 (indicating that the user A is responding). It is noted that the message 103B includes information (such as identification information, transmitted time information, message number) specifying a message (in this example, the message Mb2) to which the message 103B corresponds.

### Modified Example 3

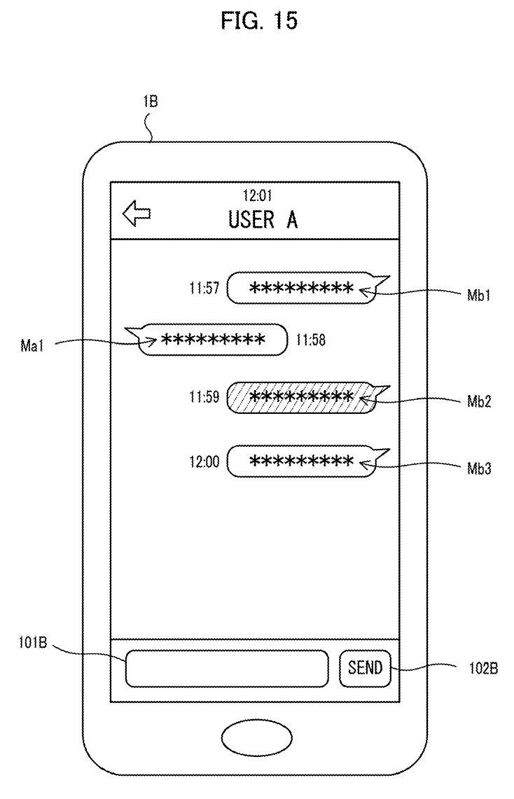

When the notification processing portion 115B of the mobile terminal 1B receives the input start information from the mobile terminal 1A, the notification processing portion 115B may change a display mode of the message Mb2 corresponding to the input start information on the display portion of the operation/display portion 13B (see FIG. 15). For example, the notification processing portion 115B changes a frame color, frame size, background color, background pattern, character color, character size, character font, character style, or character decoration of the message Mb2 displayed on the display portion.

### Modified Example 4

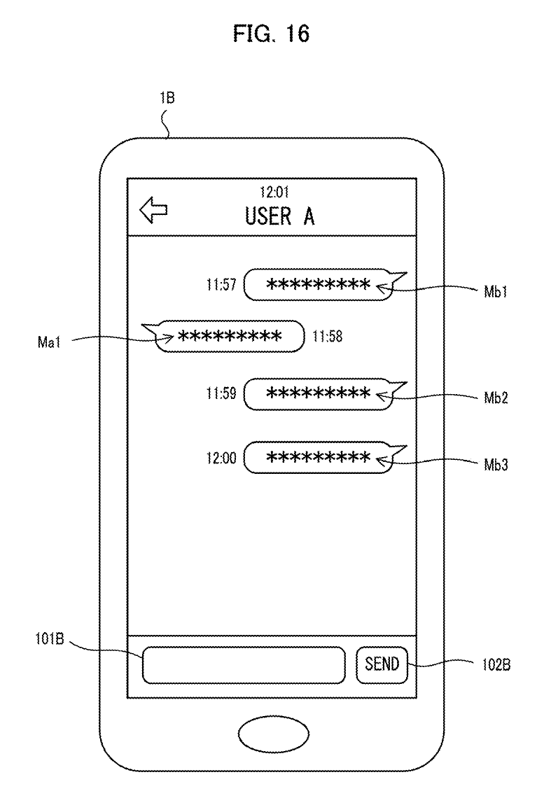

In the mobile terminal 1 (for example, the mobile terminal 1A) according to the present embodiment, when the reception processing portion 111A receives a number n (n being an integer greater than or equal to 1) of the message Mb from the mobile terminal 1B, after characters are started being input in the character input field 101A for the reply message Ma2 in response to the message Mb2, and before the transmit command to transmit the reply message Ma2 is received (while the user A is inputting characters), the notification processing portion 115A may associate the input start information with the identification information of the message Mb2, and transmit the pieces of information to the mobile terminal 1B. In this case, the notification processing portion 115A adds, to the input start information, the identification information (“003”) of the message Mb2 that had been received by the reception processing portion 111A from the mobile terminal 1B immediately before the user A started inputting characters in the character input field 101A, and identification information (“005”) of the reply message Ma2 that is created by the user A inputting characters in the character input field 101A. With this configuration, for example, the notification information (“responding→”) shown in FIG. 8 is displayed in the mobile terminal 1B after the message Mb3 is transmitted to the mobile terminal 1A (see FIG. 16).

In addition, in the mobile terminal 1 (for example, the mobile terminal 1A) according to the present embodiment, when characters for the message Ma2 to be transmitted to the mobile terminal 1B are started being input in the character input field 101A, the notification processing portion 115A may associate the input start information with the identification information of the message Mb2, and transmit the pieces of information to the mobile terminal 1B. In this case, the notification processing portion 115B may display the notification information (“responding→”) shown in FIG. 8 on the message Mb2 in the mobile terminal 1B, after the message Mb3 is transmitted to the mobile terminal 1A while characters are being input in the mobile terminal 1A (see FIG. 16).

It is noted that the “n” may be set, for example, by the user A using the mobile terminal 1A and the user B using the mobile terminal 1B.

It is possible to configure the message processing program described above to be executable in the mobile terminal 1 by installing an application corresponding to the communication tool to the mobile terminal 1 via the communication network N1. In addition, the message processing program may be saved in a server or a cloud, and the mobile terminal 1 may execute the message processing program by connecting to the server or the cloud via the communication network N1.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing apparatus, comprising:
a reception processing portion configured to receive a first message from a first information processing apparatus;
a display processing portion configured to display, on a display portion, the first message received by the reception processing portion; and
a notification processing portion configured to, when an input operation is started, associate input start information indicating that the input operation has started, with identification information of the first message, and transmit the input start information and the identification information to the first information processing apparatus, the input operation being an operation of inputting one or more characters for a second message to be transmitted to the first information processing apparatus, in an input field displayed on the display portion.

2. The information processing apparatus according to claim 1, wherein
the notification processing portion notifies the first information processing apparatus that the one or more characters for the second message that is a reply message in response to the first message, are being input in the information processing apparatus.

3. The information processing apparatus according to claim 1, further comprising
a message processing portion configured to transmit the second message to the first information processing apparatus, wherein
the message processing portion adds, to the second message, time information indicating when the input operation was started, and transmits the second message to the first information processing apparatus.

4. The information processing apparatus according to claim 1, wherein
when the reception processing portion receives a third message from the first information processing apparatus after the input operation of the second message is started and before a transmit command to transmit the second message is received, the display processing portion displays the third message adjacent to the first message on the display portion.

5. The information processing apparatus according to claim 4, wherein
when the transmit command to transmit the second message is received, the display processing portion displays the second message in between the first message and the third message on the display portion.

6. The information processing apparatus according to claim 1, wherein
when at least one message is received from the first information processing apparatus after the input operation of the second message is started and before a transmit command to transmit the second message is received, the notification processing portion associates the input start information with the identification information of the first message, and transmits the input start information and the identification information to the first information processing apparatus.

7. An information processing system configured to transmit and receive messages between a first information processing apparatus and a second information processing apparatus, comprising:
the second information processing apparatus, comprising
a first reception processing portion configured to receive a first message from the first information processing apparatus,
a first display processing portion configured to display, on a first display portion, the first message received by the first reception processing portion, and
a first notification processing portion configured to, when an input operation is started, associate input start information indicating that the input operation has started, with identification information of the first message, and transmit the input start information and the identification information to the first information processing apparatus, the input operation being an operation of inputting one or more characters for a second message to be transmitted to the first information processing apparatus, in an input field displayed on the display portion; and
the first information processing apparatus, comprising
a second display processing process configured to display the first message on a second display portion, and
a second notification processing portion configured to, when the input start information is received from the first notification processing portion, based on the identification information of the first message associated with the input start information, add to the first message notification information indicating that one or more characters for the second message are being input in the second information processing apparatus, and display the notification information in the second display portion.

8. An information processing method, comprising:
receiving a first message from a first information processing apparatus;
displaying, on a display portion, the first message that is received; and
when an input operation has started, associating input start information indicating that the input operation has started with identification information of the first message, and transmitting the input start information and the identification information to the first information processing apparatus, the input operation being an operation of inputting one or more characters for a second message to be transmitted to the first information processing apparatus, in an input field displayed on the display portion.
